(19) United States
(12) Patent Application Publication
(10) Pub. No.: US 2002/0016737 A1
(43) Pub. Date: Feb. 7, 2002

(54) Method and apparatus for offering promotional incentives on the World-Wide-Web

(76) Inventors: Henry V. Izzo, Bridgewater, NJ (US); Thomas M. Collins, Nazareth, PA (US); Neil A. Willcocks, Flanders, NJ (US); Kevin L. Rabinovitch, Hackettstown, NJ (US); Robert W. Tuttrup, Sparta, NJ (US); Mark J. Chimel, Long Valley, NJ (US)

Correspondence Address: FITZPATRICK CELLA HARPER & SCINTO, 30 ROCKEFELLER PLAZA, NEW YORK, NY, 10112, US

(21) Appl. No.: 09/855,585

(22) Filed: May 16, 2001

Related U.S. Application Data
(60) Provisional application No. 60/216,786, filed on Jul. 7, 2000.

(51) Int. Cl. G06F 17/60

(52) U.S. Cl. 705/14

(57) ABSTRACT

A method of administering a promotional contest comprises the steps of: providing to a consumer a product the label of which includes the identification code, enabling the consumer to input the identification code into a prize redemption system, validating the identification code, and determining whether the code is a winning code that entitles the consumer to receive a prize.

### CROSS-REFERENCE TO RELATED APPLICATION

This application claims benefit of U.S. Provisional Application No. 60/216,786, filed Jul. 7, 2000, which is hereby incorporated by reference.

### BACKGROUND OF THE INVENTION

1. Field of the Invention

The present invention relates to methods and apparatuses for offering promotional incentives. In particular such methods and apparatuses that utilize the World Wide Web to facilitate consumer participation in the promotional incentive.

2. Related Background

It is a well known technique in the marketing of goods or services for manufacturers to offer to consumers promotional incentives to make particular purchases. One such promotional technique involves the manufacturer including items within the packaging of its products, or alternatively on the packaging itself, that provide an opportunity for the consumer to win some type of prize. Soft drink manufacturers, for example, have been known to offer promotions in which each bottle cap is provided with a removable panel which, when removed, indicates to the consumer whether or not he or she has won a prize. In such techniques, the large majority of caps manufactured include an indication that a prize has not been won, and a small number indicate that the prize has been won.

Such promotional incentive techniques, however, have certain drawbacks, among them being the requirement that the placement of the winning indicators be carefully monitored and controlled to ensure fairness of the promotion and prevent unscrupulous persons from attempting to “fix” the results of the promotion. To adequately protect the integrity of the promotion, manufacturers are often required to retain outside agencies to administer and audit the entire process, at considerable added expense. Such agencies conventionally are given the winning items and the responsibility not only to maintain secrecy but also to physically disburse the entries throughout the geographic region covered by the promotion. This technique is cumbersome, costly, and not entirely tamper-proof.

Another problem with the conventional approach is that once the top prizes have been awarded, the word gets out, either through publicized award ceremonies, or by word of mouth, that the top prizes are no longer available, undercutting the continued effectiveness of the promotion. This is particularly true in promotional techniques where there is only one very large top prize, such as a $1 Million instant coupon associated with a purchased product.

The traditional approach in awarding prizes also carries with it the disadvantage of limited contact between the consumer and the manufacturer. More specifically, in conventional models, consumers holding losing tickets have no incentive to register with or otherwise contact the manufacturer; only winners have an incentive to make contact. This makes conventional approaches to awarding prizes less than optimal for achieving consumer outreach and contact. This problem is particularly acute when one considers that research indicates that promotions tend not to increase aggregate sales. This fact, together with a lack of consumer contact, makes the overall worth of conventional promotions questionable.

Also, the conventional promotional model discussed above suffers from the drawback of affording the manufacturer little or no control over how many prizes must be paid out, the timing of such payouts and the overall duration of such contests.

Another disadvantage of conventional promotional techniques is that they can require significant lead times between the decision to run a promotion and the actual date the promotion can begin. This is especially true when the promotion involves a modification to the package label or wrapper, as the new packaging material must be printed, applied to the product and then distributed throughout the pipeline.

One current promotional technique that utilizes promotional codes printed on package labels is Kellogg's “Eet and Ern” promotion, which at the time of filing this application may be accessed on the Web at: http://www.kelloggs.com/KWhtml/entry_points/index.html.

In the Kellogg promotion, consumers purchase specially marked Kellogg products having game codes printed on the packaging. By entering the codes from the package at the game Web site, after having been registered, participating consumers accumulate points that can be used to redeem toys and other items displayed on the Kellogg Web site. While the Kellogg promotion takes advantage of the Internet for entering codes, it is not a game or contest, since awards are not won on the basis of which codes are on the packages purchased. In the Kellogg, all codes are of equal value and the object is simply to accrue as many points as possible, as in a frequent flyer program, or S & H Green Stamps.

Thus, the need exists for promotional techniques that solve the above-mentioned problems of the prior art, while at the same time providing the consumer the opportunity to participate in a contest of chance, affording the opportunity to win prizes.

### SUMMARY OF THE INVENTION

In view of the above-described deficiencies of the prior art techniques, the present invention provides improved methods and apparatuses for providing on-line promotional contests.

In accordance with one advantageous aspect of the present invention, there is provided a method of administering a promotional contest. The method comprises the steps of: providing to a consumer a product the label of which includes an identification code; enabling the consumer to input the identification code into a prize redemption system; validating the identification code; and determining whether the code is a winning code that entitles the consumer to receive a prize.

In accordance with another advantageous aspect of the present invention, there is provided a server operable to run a prize redemption program in which a consumer has previously been provided with a product the label of which includes an identification code. The server is operable to: enable the consumer to input the identification code into a prize redemption system; validate the identification code; and determine whether the code is a winning code that entitles the consumer to receive a prize.

In accordance with yet another advantageous aspect of the present invention, there is provided computer code executable on a server operable to run a prize redemption program in which a consumer has previously been provided with a product the label of which includes an identification code. The computer code comprises: code for enabling the consumer to input the identification code into a prize redemption system; code for validating the identification code; and code for determining whether the identification code is a winning code that entitles the consumer to receive a prize.

In accordance with still another advantageous aspect of the present invention, there is provided an apparatus for administering a promotional contest in which a consumer has been provided access to a product the label of which includes an identification code. The apparatus comprises: means for enabling the consumer to input the identification code into a prize redemption system; means for validating the identification code; and means for determining whether the code is a winning code that entitles the consumer to receive a prize.

### BRIEF DESCRIPTION OF THE DRAWINGS

FIG. 1A is a block diagram of an Internet based implementation of the promotional method and apparatus of the present invention; and

FIG. 1B is a block diagram of a server/host computer of the Internet based implementation illustrated in FIG. 1A.

### DETAILED DESCRIPTION OF THE PREFERRED EMBODIMENTS

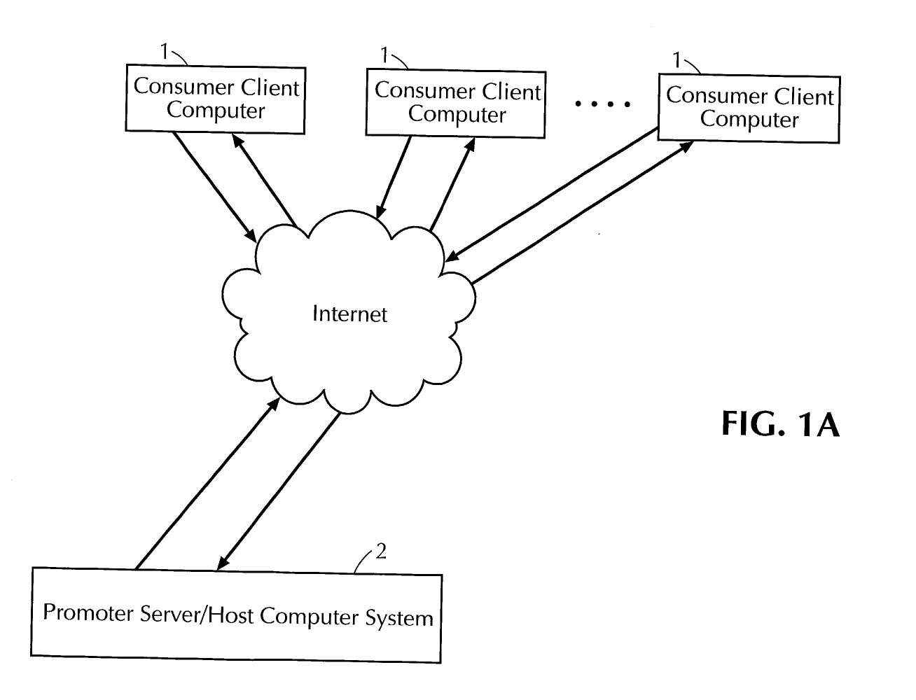

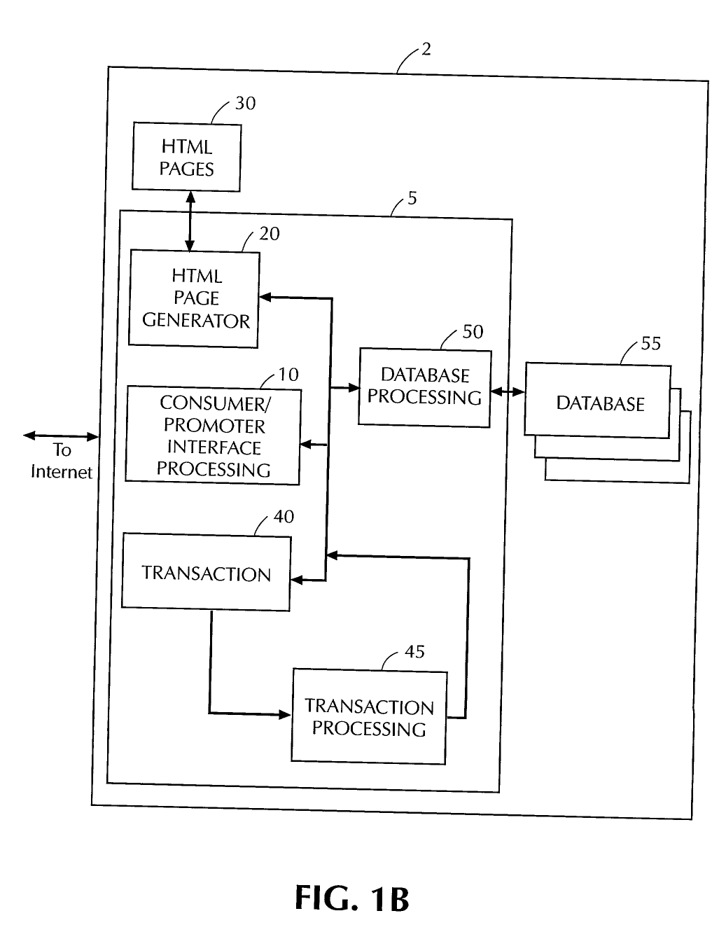

FIGS. 1A and 1B illustrate hardware and software for implementing preferred embodiments of the method and apparatus for awarding prizes according to the present invention.

In a preferred embodiment of the present invention, a wide area network (WAN), such as the Internet, is utilized. Preferably included is an Internet (TCP/IP compliant) server that interacts with consumer client computers using the consumer computer's graphical user interface (GUI). The interface with the consumer computer preferably allows the consumers to connect to a promoter's computer in order to input identification codes, as will be described in more detail below. The above functionality is preferably achieved using a combination of server side applications, such as common gateway interface programs (CGI), for allowing the server to accept search terms and interface with databases, and consumer side applets, such as Java applets, or the like, which execute in consumer browser software.

A preferred implementation of the present invention is illustrated in block diagram form in FIG. 1A. In that figure, consumers operating computers 1 are connected to a wide area network (WAN) such as the Internet. Such connection can be direct or via an Internet service provider (not shown). The consumer computers 1 each preferably include communications hardware and an operating system with graphical user interface (GUI) functionality to allow for interface with the Internet. Each consumer computer preferably has graphical World Wide Web (Web) browser software, such as Netscape Navigator or Microsoft Internet Explorer, loaded thereon operable to read and send Hypertext Markup Language (HTML) forms from and to an Hypertext Transfer Protocol (HTTP) server on the Web. Other programming languages can be used, such as Extensible Markup Language (XML) and the sub-languages derived from XML. The consumer computer 1 preferably is operable to act as a virtual machine to run Java applets, or the like, downloaded by the browser from the server.

Promoter server/host computer system 2 receives information from consumer computers 1 over the Internet. The promoter server system 2 preferably includes hardware, HTTP compliant software, an operating system and common gateway interface (CGI) software for interfacing with input queries and sources of data.

A preferred implementation of the promoter server/host computer system 2 is illustrated in block diagram form in FIG. 1B.

As shown in the figure, promoter server/host system 2 is controlled by software functions of server process 5. Among the constituent software components within the server process 5 is the consumer interface process 10. Consumer interface process 10 functions to interface with, in the preferred embodiment, consumer computers 1. Interface process 10 executes functions in response to input from consumer computers 1. HTML page generator 20 responds to requests from the consumer computers 1 for HTML pages 30, which themselves are stored in, or are available to, the server. Transaction 40 stores information for the present transaction and the transaction is completed by transaction processing module 45. Database process 50 interfaces the server process 5 with database 55, using CGI techniques well known in the art.

In operation, in the Internet implementation, a consumer typically would type in a Uniform Resource Locator (URL) of the promoter server/host 2 and receive from the promoter server 2 an interactive form, such as an HTML document, as well as any Java applets, or similar object-oriented code suitable for running on the consumer's browser.

In a preferred embodiment of the present invention, a consumer wishing to participate in the promotion of the present invention must begin by registering for the promotion. The registration form is preferably presented as a HTML form on the Web site of the promotion and will contain several required fields that could be useful to the promoter. Preferably, all such information is stored, and may be retrieved, utilizing CGI techniques known in the art. The registration information may include information such as the registrant's name, e-mail address, ethnicity, address, age, gender, income, education, etc. In addition to its use in managing the game, the gathered information is available for use in a marketing/consumer research context. When registration data is entered, the consumer preferably is afforded the opportunity to choose a username and password for their account, and preferably a free entry code for the promotion as a “thank you” for participating in the promotion.

To begin the prize verification process the consumer enters an identification code or number that he or she has taken from a wrapper or other packaging associated with a qualified product, or included within such packaging. Preferably, the software controlling the promoter server/host computer 2 is operable to cause the computer to send to the consumer instructions as to how to enter additional codes, if any, for example by providing a prompt and a hypertext link to additional data entry HTML forms.

In practice, in the Internet implementation, when the consumer has purchased promotional product and wishes to enter new identification code numbers into his or her account, the consumer enters into his or her browser the URL that brings the consumer to the home Web site of the promoter. Upon entering the site, the consumer is preferably presented with a particular HTML page 30. The presented page preferably includes a form for entering additional identification codes. The form is generated by HTML page generator 20 to provide a user interface for transaction 40. When the consumer enters his or her additional identification code, that code is stored via database process 50 on database 55 to associate that code with a username created for the consumer during the registration process. After storage of the code, transaction process 45 determines whether the code is a valid code.

The code entered by the consumer can be validated in a number of ways. The simplest way is to compare the entered code with a list of active codes, preferably stored in database 55. A preferred additional method of verification utilizes a two-part code—one half of the code is the unique identification code which can only be viewed by opening the package and the other half is the manufacturer's code date/manufacturing information. Within database 55, the valid pairs of identification code and code dates (based on time of manufacturing) are stored.

Another preferred method of code validation is to incorporate an internal self-consistency in the identification codes, such as a check-sum value. An example of this would be to require that the 2^{nd} and 5^{th} digit of the code must always sum to 13. An important aspect of the validation cycle is the tracking in database 55 of the number of codes that have been entered and determined by transaction process 45 to be invalid codes. The promoter can establish a threshold for the acceptable number of invalid codes that may be entered. Any consumer/user who exceeds this limit may be rejected from the system and not permitted to participate in the promotion or referred to a system administrator. This is to discourage fraudulent entries and systems such as “war dialing”, in which a computer is programmed to send numbers or codes to another computer continuously.

If transaction process 45 determines that the code is valid, database process 50 notes this fact in database 55. Regardless of the details of the prize structure of the promotion, in the preferred embodiment of the present invention, valid codes fall into one of five classes as follows: expired, redeemed, winning, pending and losing.

Expired codes are identification codes that are not within the scope of the current promotion (i.e. they are too old). Redeemed codes are codes that are associated with prizes where the consumer has already redeemed their prize(s). Winning codes are codes associated with prizes where the consumer has not yet redeemed their prize(s). Pending codes are codes that are active in the current promotion but have not yet been designated as winning or losing codes. Losing codes are active in the current promotion, but are not associated with primary prizes.

In one embodiment of the invention, entry of a sufficient number of losing, but valid, codes can make the consumer eligible for a “consolation” prize. This advantageously reduces consumer discouragement that accompany repeatedly being informed that you have not won a prize. After the class of the identification code has been determined, database 55 is updated to reflect the classes of the identification codes.

After server process 5 has accepted, validated and recorded the identification code, the consumer has the opportunity to review his or her game status by accessing the account information stored in database 55 via an appropriate one of HTML pages 30. Database process 50 uses known CGI techniques, for example, to move information into and out of the database 55 and to and from the consumer. The HTML page viewed by the consumer can take several forms. In one embodiment, that consumer's previously entered identification codes are made visible on the promoter's HTML home page and his or her status (as indicated by the classes described above) is automatically updated when there is a change. In another embodiment, the consumer actively requests, for example by clicking on a link, that the display be updated. In one preferred embodiment of the present invention, when an identification code's status changes to winner, the consumer who owns that code is sent an e-mail notification of the class change of his or her identification code.

A number of advantageous embodiments for implementing the present invention are outlined below. Of course, the present invention is not limited to the illustrated embodiments.

In one such embodiment, any identification code or number associated with a prize is previously assigned as a winner/loser and the consumer, upon checking in to the prize redemption Web site, is instantly advised as to their prize status upon entry of the code. The previous assignment of the winning code or codes is preferably performed completely at random, for example, by means of random number generating algorithms well known in the art. Preferably, upon entry of a code by the consumer, the server simply compares the entered number with a secure database area reserved for winning numbers. Alternatively, the winning numbers can be accessible over a secure link from a remote prize verification server, either in the control of the promoter or of an outside monitoring agency. The verification by the prize verification server can be made by offering the consumer a link to that server. In a variation of this embodiment, the system is programmed to distribute winners at a predetermined rate throughout the promotional period to avoid a problem in which customers lose interest after hearing about a winner early in the promotional period.

In a variation of the foregoing embodiment, the winning and losing codes are predetermined in the manner discussed above. However, in the variation, the notification of the code's status as a winning code is deferred until end of promotional period. This is preferably accomplished by storing the username of the consumer entering the winning code in a winners area in the database, together with the winning code, and notifying the winner, preferably by e-mail, at the end of the promotional period.

In another advantageous embodiment of the present invention, the act of entering an identification code has the effect of placing that code in a virtual hat. The virtual hat would preferably be comprised of locations in a database, either stored at the promoter computer server, or at a remote site of an outside verification agency. At the end of the promotional period, a number is virtually drawn from the virtual hat, for example by use of a random number generating algorithm. To ensure fairness and to engender confidence in the results, the generation of the winning code or codes also may preferably be performed independently of the promoter's site. The winner is notified, by e-mail or by any other conventional means. Alternatively, instead of sending an e-mail notification to the winner, the winning number may be posted on a Web site, preferably the Web site of the promoter. In another variation, to induce additional purchases, each purchase provides the purchaser another chance in the virtual hat for prize drawings.

In a variation of the foregoing embodiments, a “small” prize may be pre-associated with certain of the codes, to be awarded immediately, while other codes are placed in a virtual hat, to be drawn from at the end of the promotion period. This method has the advantage of maintaining interest in the promoter's Web site, since there is always the chance of being awarded an instant prize, while at the same time stimulating long term interest that results from the fact that larger prizes will be awarded in the future.

In another embodiment of the present invention, a prize associated with an entered code is randomly generated at the time the consumer enters his or her code and the consumer is instantly advised whether they have won a prize. This embodiment offers increased consumer excitement since each entry of a code acts in much the same way as a virtual slot machine. This embodiment is preferably implemented by utilizing a random number generating algorithm and comparing some or all of the digits of the entered code with the number produced by the random number generator.

The random prize generation technique described in the foregoing paragraph can be substituted for the pre-assigned winning codes in any of the previously described embodiments described as utilizing pre-assigned winning codes. Alternately, a combination of pre-assigned winning codes and instant random winners can be implemented as a variation of any of the embodiments described above. For example, in such a variation, upon entry of a code by the consumer, the server computer performs a random number generation operation and the generated random number is compared to the entered code. If the numbers match, the consumer is an instant winner, and is so informed. If there is no match, the consumer is informed immediately that, while not an instant winner, the number will be entered into the virtual hat for a later drawing for a prize.

In another embodiment of the present invention, the entered code is placed into a virtual hat, as in previously described embodiments, but with multiple periodic draws for winners. This technique has the advantage of maintaining consumer interest in the promotion over a longer period of time, since the periodic draws offer the promoter the opportunity to advise consumers of upcoming drawing dates throughout the promotional period. Preferably, in this embodiment, the promoter has the option of carrying over codes from one draw to the next. Thus, a losing code for the first half of the promotion may become a winning code in the second half. This would entail a new draw, in the manner described above, of all previously entered codes, even those previously determined to be losing codes. Preferably, the promoter retains the right to exclude from any subsequent draw winning codes from any previous drawing period.

The present invention allows the number of winners and the odds of winning to be adjusted by the administrator.

In one embodiment, this functionality is utilized to, for example, provide more prizes at the beginning of the promotional period and reducing the number of prizes as the promotion goes on. To offset this, it is possible to increase, that is “ramp up”, the value of the prizes that are awarded as the number is decreased. This technique would provide a strong incentive to play early, as the odds of winning are greater, while continuing to provide interest in the promotion throughout the promotional period by means of the ever-increasing prize values.

Another embodiment of the present invention uses the virtual hat technique described in detail above. However, in this embodiment, instead of drawing a code at a specified date, a cut-off date for entry is set. After that cut-off date, the pool of codes diminishes over time. This can be accomplished by using a random number generating algorithm to generating random codes to delete from the pool, either at a fixed rate, or at certain specified times during the promotion. To add to the excitement, the consumers can check, for example on the Web site of the promoter, at any time during the promotion to see if their numbers are still “alive”. An especially preferred variation of this embodiment would have the total set of code-containing wrappers be distributed and certain codes start dying off at a specified time. When the consumer enters his or her code at the Web site, he or she is informed if that code is still alive or has already expired.

Preferably, in any of the above scenarios, consumers who have registered on the Web site are provided with the ability to check on the status of their codes simply be going to the Web site of the promotion. Upon entry to the site, the consumer signs in either automatically, by server recognition of cookies previously placed in the consumer's computer, or by the consumer signing in with his or her username and password.

In an advantageous variant of any of the above scenarios, a consumer may pool and “cash-in” small prizes for a larger prize, thus encouraging small winners to continue playing and not simply assume they have received their one lucky break. In addition, or alternately, consolation prizes can be provided whereby a certain number of non-winning codes will be sufficient to win a prize.

In the above scenarios, for verification purposes, contest code and code date (indicating information such as date and time of manufacture, manufacturing facility, expiration date, etc.) can be checked by the server so that the manufacturer remains aware of what prize codes were associated with which codes dates.

Combining registration information (name, age, address, etc.) with promotional code entry history can provide a source of market research/consumption data. To prevent cheating, if a consumer enters an excessive number of invalid combinations, that consumer is preferably disqualified from further participation.

Note that it is preferable in the present invention to continually print codes on products even when promotions are not active, thus affording an opportunity to start a promotion instantly by declaring that all products past a certain code date are now eligible. This would have the advantage of increasing the number of hits at the Web site as people would check in periodically to find out about any new promotions that may be offered.

Although the present invention has been described as involving reading a game code off of packaging, in an alternative way of participating in the game, instead of reading a code off of packaging, a consumers can receive a code, and thus a chance to win, as a reward for providing demographic data about themselves at the Web site. This will provide the consumer with incentive to continue the game, in order to obtain more codes, by purchasing products having the codes.

Although the present invention has been described in terms of an example that includes the Internet and a Web site, the present invention is not so limited. The identification code to be discussed in detail below could, for example, be entered at a standalone kiosk which might be connected to a center connection via the Internet or some other medium. Alternatively, the identification code could be entered through a telephone system and either a manual or automated call handling system on the receiving end. Another example would be to link a promotion to other enterprises, for example, on a mall-wide scale, e.g., “at the Lehigh Valley mall tonight a winner will be declared just before the mall closes”.

Other variations and modifications of this invention will be apparent to those skilled in this art after careful study of this application. This invention is not to be limited except as set forth in the following claims.

What is claimed is:

1. A method of administering a promotional contest comprising the steps of:
providing to a consumer a product the label of which includes an identification code;
enabling the consumer to input the identification code into a prize redemption system;
validating the identification code; and
determining whether the code is a winning code that entitles the consumer to receive a prize.

2. A method according to claim 1, wherein the consumer inputs the identification code via the Internet.

3. A method according to claim 1, wherein the consumer inputs the identification code at a kiosk.

4. A method according to claim 1, wherein the consumer inputs the identification code by telephone.

5. A method according to claim 1, wherein the determining step determines whether the code is a winning prize that entitles the consumer to receive a prize by comparing the validated identification code with stored winning numbers.

6. A method according to claim 1, wherein the determining step determines whether the code is a winning code that entitles the consumer to receive a prize by placing the validated code in a virtual hat with other codes and drawing from the virtual hat.

7. A method according to claim 1, wherein the determining step determines whether the code is a winning code that entitles the consumer to receive a prize by generating a random number using a random number generator and comparing one or more digits of the validated code with the random number.

8. A server operable to run a prize redemption program in which a consumer has previously been provided with a product the label of which includes an identification code, the server being operable to:
enable the consumer to input the identification code into a prize redemption system;
validate the identification code; and
determine whether the code is a winning code that entitles the consumer to receive a prize.

9. A server according to claim 8, wherein the server is on the Internet.

10. A server according to claim 8, wherein the server determines whether the code is a winning prize that entitles the consumer to receive a prize by comparing the validated identification code with stored winning numbers.

11. A server according to claim 8, wherein the server determines whether the code is a winning code that entitles the consumer to receive a prize by placing the validated code in a virtual hat with other codes and drawing from the virtual hat.

12. A server according to claim 8, wherein the server determines whether the code is a winning code that entitles the consumer to receive a prize by generating a random number using a random number generator and comparing one or more digits of the validated code with the random number.

13. Computer code executable on a server operable to run a prize redemption program in which a consumer has previously been provided with a product the label of which includes an identification code, the computer code comprising:
code for enabling the consumer to input the identification code into a prize redemption system;
code for validating the identification code; and
code for determining whether the identification code is a winning code that entitles the consumer to receive a prize.

14. Computer code according to claim 13, wherein the server is on the Internet.

15. Computer code according to claim 13, wherein the server determines whether the identification code is a winning code that entitles the consumer to receive a prize by comparing the validated identification code with stored winning numbers.

16. Computer code according to claim 13, wherein the server determines whether the identification code is a winning code that entitles the consumer to receive a prize by placing the validated code in a virtual hat with other identification codes and drawing from the virtual hat.

17. Computer code according to claim 13, wherein the server determines whether the identification code is a winning code that entitles the consumer to receive a prize by generating a random number using a random number generator and comparing one or more digits of the validated code with the random number.

18. An apparatus for administering a promotional contest in which a consumer has been provided access to a product the label of which includes an identification code, the apparatus comprising:
means for enabling the consumer to input the identification code into a prize redemption system;
means for validating the identification code; and
means for determining whether the code is a winning code that entitles the consumer to receive a prize.

19. An apparatus according to claim 18, wherein the consumer inputs the identification code via the Internet.

20. An apparatus according to claim 18, wherein the consumer inputs the identification code at a kiosk.

21. An apparatus according to claim 18, wherein the consumer inputs the identification code by telephone.

22. An apparatus according to claim 18, wherein the determining means determines whether the code is a winning prize that entitles the consumer to receive a prize by comparing the validated identification code with stored winning numbers.

23. An apparatus according to claim 18, wherein the determining means determines whether the code is a winning code that entitles the consumer to receive a prize by placing the validated code in a virtual hat with other codes and drawing from the virtual hat.

24. An apparatus according to claim 18, wherein the determining step determines whether the code is a winning code that entitles the consumer to receive a prize by generating a random number using a random number generator and comparing one or more digits of the validated code with the random number.
